(19) United States
(12) Patent Application Publication
(10) Pub. No.: US 2006/0238441 A1
(43) Pub. Date: Oct. 26, 2006

(54) Method and apparatus for displaying a stereoscopic image

(75) Inventors: Ronald G. Benjamin, Lake Forest, CA (US); Kevin M. Doyle, Long Beach, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: The Boeing Company

(21) Appl. No.: 11/113,737

(22) Filed: Apr. 25, 2005

(51) Int. Cl. G09G 5/00

(52) U.S. Cl. 345/8

(57) ABSTRACT

A stereoscopic display apparatus includes a mount, an arm connected to the mount for movement relative to the mount, and a pair of independent visual displays mounted on the arm for movement relative to the mount so that the pair of displays is positionable for viewing by a user. A first display of the pair is adapted for viewing by a first eye of the user and a second display of the pair is adapted for viewing by a second eye of the user. Each display of the pair is adapted to cooperate with the other display to provide images to the respective eye of the user that are perceived by the user as a three-dimensional image.

### BACKGROUND OF THE INVENTION

The present invention relates generally to displaying an image, and more specifically to a method and apparatus for displaying a stereoscopic image.

Aircraft known as tankers are used to refuel military aircraft during long flights. Most large tankers include a boom through which fuel is delivered to the aircraft being refueled. The boom engages a fueling port on the aircraft being refueled. Refueling boom operators located onboard tankers are required to view the refueling boom to direct the boom as it engages the fueling port. Typically, the operator is located in a refueling pod in the rear of the aircraft and the pod is equipped with a large window to give the operator direct line of sight to the refueling boom. However, such windows may be costly and difficult to form. Additionally, such windows may detract from an overall strength of the structure of the aircraft. Moreover, if such a window failed during flight it could cause significant damage to the aircraft or injury to personnel inside the aircraft.

To eliminate large windows, some tankers use a pair of laterally separated cameras (i.e., a left camera and a right camera), housed in an enclosure positioned at the rear of the tanker. These cameras provide an operator with a view similar to that of a large window, but permit the operator to be positioned at the front of the aircraft. Such a camera video display system provides a technological substitute for normal human depth perception. This substitute is achieved by directing the images from the vantage of the right and left camera to the corresponding eyes of the boom operator. Although there are a few potential methods available for doing this, the current inventions uses small displays attached to one another and separated by a small distance corresponding to the distance between the observer's pupils. In this arrangement, the left display provides the image from the vantage of the left camera to the operator's left eye, and the right display provides the image from the vantage of the right camera to the operator's right eye. Because the cameras are aimed at a point behind the refueling tanker where a refueling boom receptacle on the receiving aircraft should be positioned during refueling, the operator is able to perceive a true three-dimensional image of the refueling scene. This perception enables the operator to maneuver the boom into the receptacle of the receiving aircraft without unintentionally contacting the boom and the receiver, which could cause damage to both the boom and the receiver. Operator awareness of the spacing between the boom and the receiver is the reason that depth perception is vital to aerial refueling.

Using separate video displays connected to separate cameras paired to provide stereoscopic vision has been used previously in an apparatus designed to be worn on the head. Such an apparatus is known as a Head-Mounted Display (HMD). An HMD positions each display over a corresponding eye by use of a variety of adjustable structural mechanisms. However, there are several notable drawbacks to the HMD concept. One drawback of an HMD is the displays obstruct the operator's view when the HMD is worn. Since the displays are mounted to a frame worn on the head, the operator cannot simply move his head to look around them. One solution to this problem is to provide a console and controls which are accessible to the operator when wearing the HMD. However, the HMD's also interfere with conventional communications headsets, emergency oxygen equipment, and chemical-biological protective garments.

### SUMMARY OF THE INVENTION

In one aspect, the present invention includes a stereoscopic display apparatus comprising a mount, an arm connected to the mount for movement relative to the mount, and a pair of independent visual displays mounted on the arm for movement relative to the mount so that the pair of displays is positionable for viewing by a user. A first display of the pair is adapted for viewing by a first eye of the user and a second display of the pair is adapted for viewing by a second eye of the user. Each display of the pair is adapted to cooperate with the other display to provide images to the respective eye of the user that are perceived by the user as a three-dimensional image.

In another aspect, the present invention includes a vehicle comprising a body, an arm connected to the body for movement relative to the body, and a pair of independent visual displays mounted on the arm for movement relative to the body so that the pair of displays is positionable for viewing by a user. A first display of the pair is adapted for viewing by a first eye of the user and a second display of the pair is adapted for viewing by a second eye of the user. Each display of the pair is adapted to cooperate with the other display to provide images to the respective eye of the user that are perceived by the user as a three-dimensional image.

In yet another aspect, the present invention includes a vehicle comprising a body, and a pair of independent visual displays mounted on the body. A first display of the pair is adapted for viewing by a first eye of the user and a second display of the pair is adapted for viewing by a second eye of the user. Each display of the pair is adapted to cooperate with the other display to provide images to the respective eye of the user that are perceived by the user as a three-dimensional image. The vehicle also includes a camera system mounted on the body and operatively connected to the pair of visual displays for receiving images and providing the received images to the visual displays.

In still another aspect, the present invention includes a method for viewing an object adjacent a vehicle. The method comprises collecting an image of the object and providing the image to a user on a pair of independent visual displays located on-board the vehicle and adapted for viewing by the user so that the images are perceived by the user as a three-dimensional image.

Other features of the present invention will be in part apparent and in part pointed out hereinafter.

### BRIEF DESCRIPTION OF THE DRAWINGS

FIG. 1 is a schematic of a stereoscopic display apparatus;

FIG. 2 is perspective of apparatus of a first embodiment of the present invention;

FIG. 3 is a front elevation of apparatus of a second embodiment of the present invention;

FIG. 4 is a detail side elevation of apparatus of third embodiment of the present invention;

FIG. 5 is a partially cutaway perspective of aircraft including another embodiment of a stereoscopic display apparatus of the present invention; and

FIG. 6 is a perspective of an aircraft illustrating a stereoscopic display apparatus of the present invention.

Corresponding reference characters indicate corresponding parts throughout the several views of the drawings.

### DETAILED DESCRIPTION OF THE PREFERRED EMBODIMENT

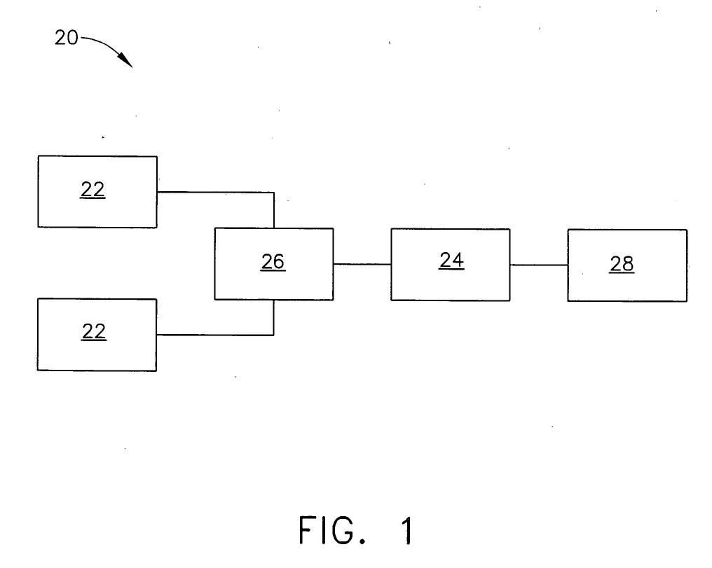

Referring now to the drawings, and more specifically to FIG. 1, a conventional stereoscopic display apparatus for use as a component of the present invention is designated in its entirety by the reference numeral 20. The apparatus 20 includes a pair of independent visual displays 22. Each display 22 is adapted for viewing by one of a pair of a user's eyes (not shown in FIG. 1). In other words, one display of the pair is positioned in front of one of the user's eyes, and the other display is positioned in front of the other of the user's eyes. Each display 22 is also adapted to cooperate with the other display to provide images to the eyes that are perceived by the user as a three-dimensional image. As will be appreciated by those skilled in the art, the images displayed by each display are slightly different in that each image is taken from a slightly different viewpoint. More particularly, in most cases each image is taken from a viewpoint that is spaced from the viewpoint of the other image by a distance approximately equal to the distance between a typical user's eyes.

A camera system 24 is operatively connected to the pair of visual displays 22 for capturing images and providing the captured images to the visual displays. The apparatus may include a processor 26 to process the images captured by the camera system 24 for display on the displays. The camera system 24 may also include a camera control 28 for controlling operation of the cameras of the system and/or for changing the orientations of the cameras.

Any suitable type, brand, and/or model camera may be included in the camera system 24 without departing from the scope of the present invention. Similarly, the camera system 24 may include any number of cameras without departing from the scope of the present invention. Although other camera systems may be used without departing from the scope of the present invention, in one embodiment the camera system is a digital video camera system having two camera lenses spaced by a distance of about twenty inches. More specifically, the camera system of this one embodiment is a Pantera TF 1M60 camera system available from DALSA Corporation of Waterloo, Ontario, Canada. In some embodiments, the camera system 24 includes a plurality of cameras positioned at different locations and/or orientations for viewing multiple objects and/or viewing a single object from multiple viewpoints. In one embodiment (not shown), a single camera is used to provide (from at least one viewpoint) images to both of the pair of displays 22. This configuration is sometimes referred to as a single camera stereoscopic video. In another embodiment, a pair of cameras is used to provide (from at least one viewpoint) images to the pair of displays 22. This configuration is sometimes referred to as double camera stereoscopic video.

Any suitable type, brand, and/or model display may be used as a display 22 without departing from the scope of the present invention. For example, in one embodiment the displays 22 include a liquid crystal display. In another embodiment, each of the displays 22 include a cathode-ray tube. Although other displays may be used without departing from the scope of the present invention, in one embodiment the display is a Digital ProView 50 display available from Kaiser Electro-Optics, Inc. of Carlsbad, Calif. As may be seen from the various embodiments of the present invention described and illustrated herein, the displays 22 used as a component of the present invention may configured in any suitable manner to interface with a user.

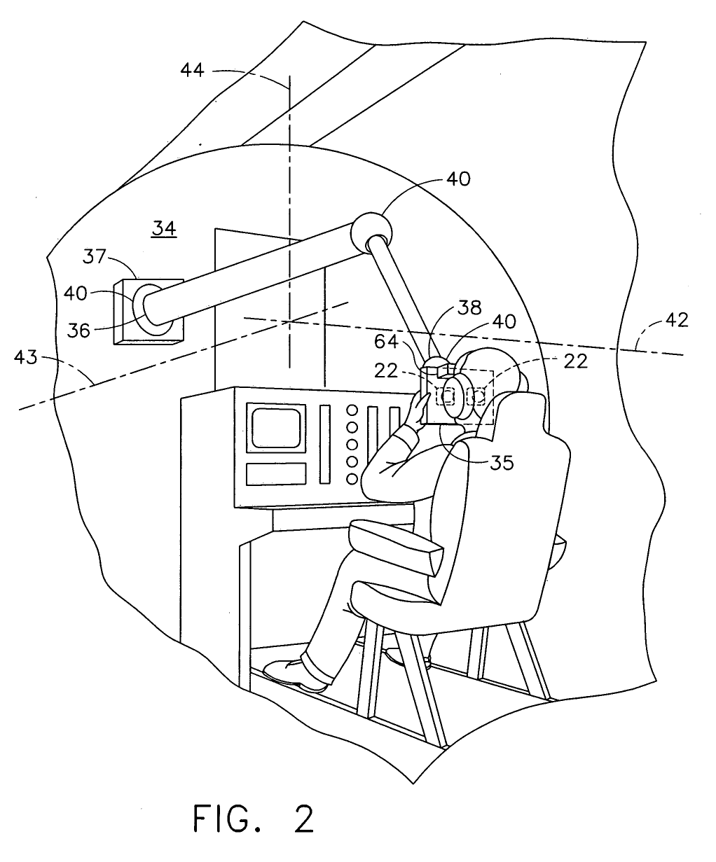

In other embodiments, the displays 22 may be mounted on arm that is connected to a mount or directly mounted on a solid body, such as a wall, floor, or ceiling of a building. As shown in FIG. 2, one embodiment of a stereoscopic display apparatus of the present invention is designated in its entirety by the reference numeral 30. The apparatus 30 includes an arm 32 mounted on a generally solid body 34. The displays 22 are contained in a housing 35 mounted on the arm 32 and the arm is generally movable with respect to the solid body 34 for positioning the pair of displays adjacent a user's eyes (not shown). The movability of the arm 32 to adjust a position of the displays 22 facilitates accommodation of the displays 22 to an eye position for various-sized users. Additionally, the movability of the arm 32 may allow the displays 22 and the arm 32 themselves to be positioned out of the way when not in use. The embodiment of the present invention having the arm 32 may be advantageous over head-mounted displays 22 by eliminating the weight of apparatus transmitted to the user.

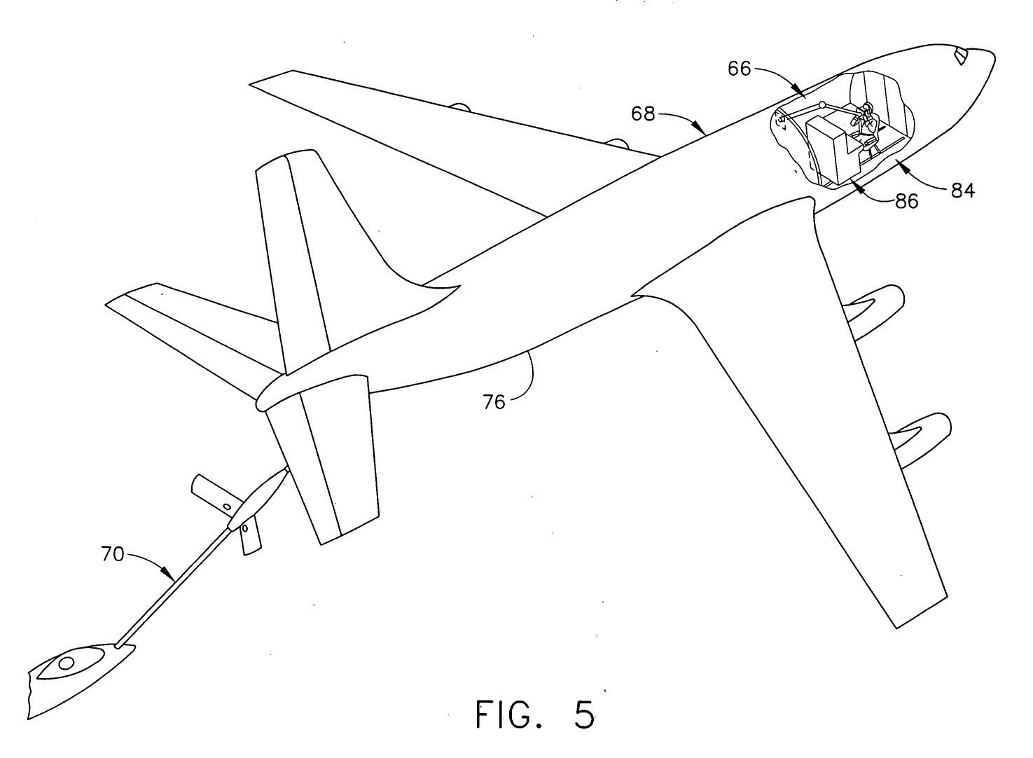

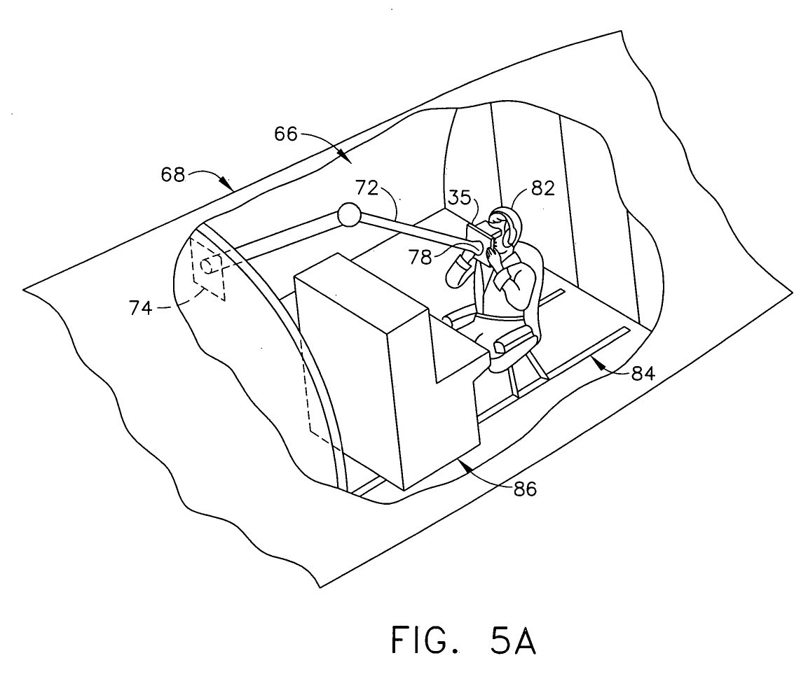

Specifically, as shown in FIG. 2 the arm 32 includes a first end 36 having a mount 37 connected to the solid body 34 and a second end 38 opposite the first end. Alternatively, any other portion of the arm of the present invention (e.g., the arm 32) may be mounted on the solid body 34 without departing from the scope of the present invention. The displays 22 are mounted adjacent the second end 38 of the solid body 34. Alternatively, the displays 22 may be mounted on any other portion of the arm 32 without departing from the scope of the present invention. The arm of the present invention is an articulating arm. As shown in FIG. 2, in one embodiment the arm 32 includes three joints 40, however the arm of the present invention may have any number of joints without departing from the scope of the present invention. Further, in the embodiment shown in FIG. 2 the second end 38 of the arm 32 is movable in three directions (generally along two horizontal axes 42, 43 and a vertical axis 44) for positioning the displays in front of the eyes of a user. Moreover, any portion of the arm may be movable in any number of direction(s) without departing from the scope of the present invention, and the arm of the present invention is not limited to the specific structure shown and/or described herein. For example, FIG. 4 illustrates an arm 52 having a plurality of telescoping joints 54 allowing the arm 52 to move along a longitudinal axis 56, and FIG. 5 illustrates an arm 58 having a rotating-ball-and-socket joint 60 that is flexible about a plurality of axes. In one embodiment, the arm of the present invention may be locked in position to secure the arm and/or the displays 22 in a desired position and/or orientation.

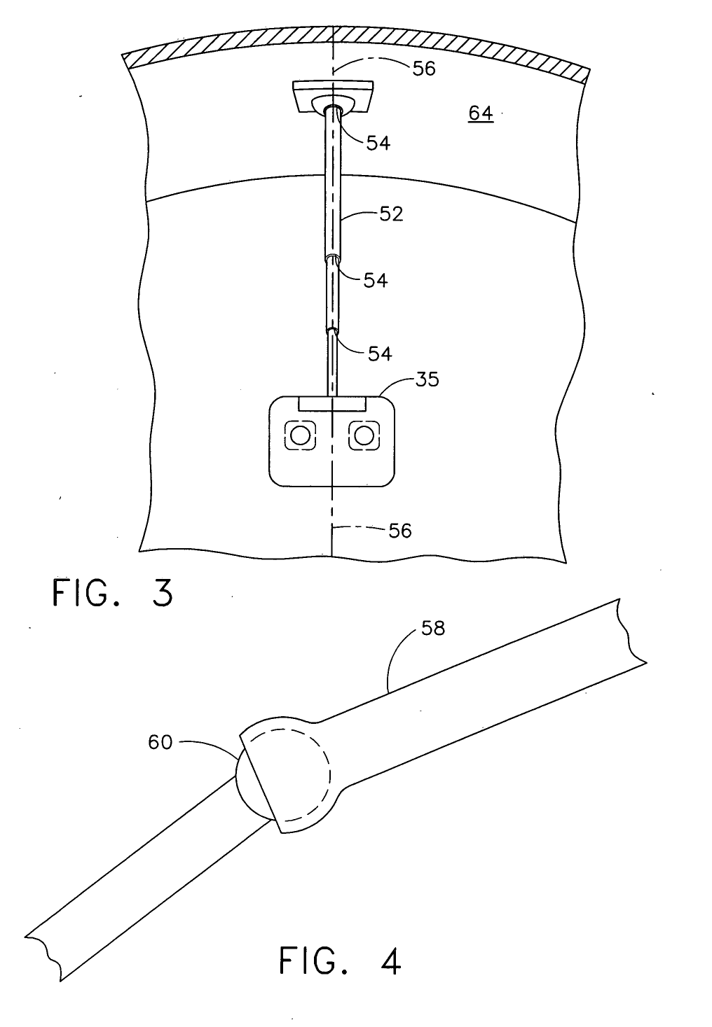

The arm of the present invention may be mounted to any generally solid surface. For example, as shown in FIG. 3, the arm 52 is shown mounted to a ceiling 64 of a building. As additional examples, the arm of the present invention may be mounted to a floor of a building or any portion of a vehicle without departing from the scope of the present invention.

In some embodiments of the present invention (e.g., the embodiment shown in FIG. 2), the apparatus includes a brow pad 64 positioned adjacent the pair of visual displays 22 for engaging the user's brow when the pair of visual displays are positioned in front of the user's eyes. In the embodiment shown in FIG. 2, the brow pad 64 is mounted on the display housing 35, however the brow pad may be mounted on other locations without departing from the scope of the present invention. The brow pad may cushion contact between the user's face and the display housing 35 and/or the displays 22 themselves. Specifically, the brow pad may facilitate enabling the user to make physical contact with the display housing 35 more comfortably and/or may facilitate dampening vibrations transmitted from the generally solid body 34 to facilitate preventing distortion of the images viewed by the user.

As described above, the camera system 24 (not shown) is operatively connected to the pair of visual displays 22 for receiving images and transmitting the received images to the visual displays. The camera system 24 may be used to receive any image of interest, including images outside the visible electromagnet spectrum. Further, the image may be of any subject. For example, the present invention may be used to stereoscopically view a patient during surgery. Another example includes stereoscopically viewing cargo and/or other materials for remote handling of such cargo and/or other materials. Other examples include stereoscopically viewing images from a camera located on a remote vehicle (e.g., unmanned aerial or ground vehicles) for control of the vehicle (including for example takeoff and landing), stereoscopically viewing a vehicle from a camera located remote from the vehicle for control of the vehicle and/or control over the movements of a plurality of vehicles, or generally stereoscopically viewing an object of interest wherein the user is onboard a vehicle.

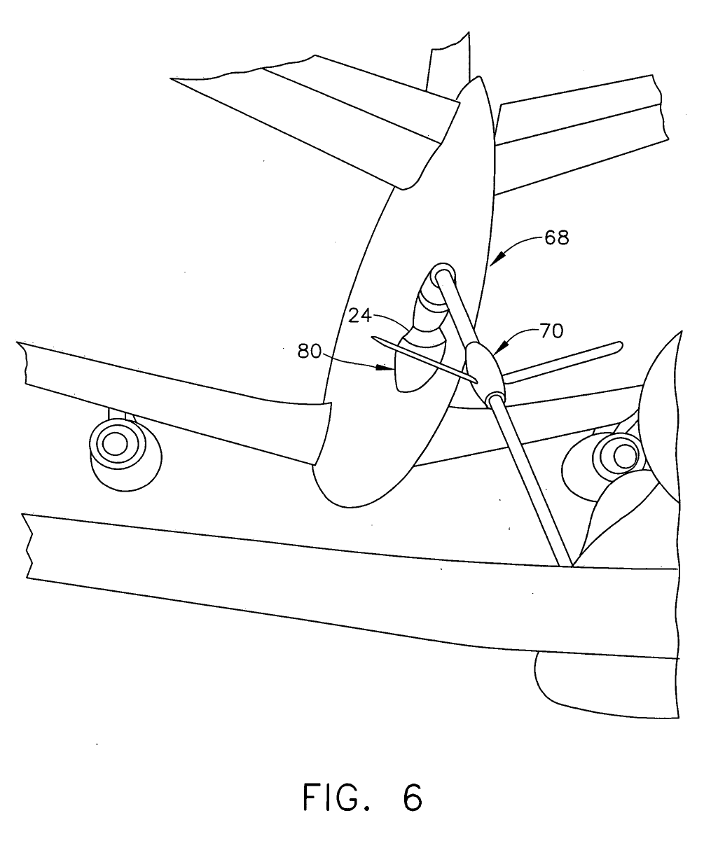

As shown in FIGS. 5 and 6, in one embodiment a stereoscopic display apparatus of the present invention (designated in its entirety by 66) is mounted on a vehicle for stereoscopically viewing an object of interest onboard and/or adjacent the vehicle. Specifically, the apparatus 66 is mounted on an aircraft (designated in its entirety by 68) for stereoscopically viewing a refueling boom (generally designated by 70) mounted on the aircraft. As shown in FIG. 5, the apparatus 66 includes an arm 72 having a first end 74 mounted on an airframe 76 of the aircraft 68 and a second end 78 opposite the first end. The displays 22 (contained within housing 35) are mounted adjacent the second end 78 of the arm 72. The arm 72 and displays 22 are generally mounted on the airframe 76 within a refueling pod (generally designated by 80 and shown in FIG. 6) of the aircraft 68. The arm 72 shown in FIG. 5 is movable for positioning the displays in front of the eyes of a refueling boom operator 82 on board the aircraft 68. The movability of the arm 72 to adjust a position of the displays 22 facilitates accommodation of the displays 22 to a seated operator 82 in a position generally designated by the number 84. Accordingly, the operator 82 can view the displays 22 while seated. In one embodiment, the operator 80 may only need lean backwards or slightly move the arm (and thus the displays 22) to have an unobstructed view of console mounted controls and/or displays (generally designated by 86). Additionally, the movability of the arm 72 may allow the displays 22 and the arm 72 to be securely stowed when not in use, such as during takeoff and/or landing. As described above, the apparatus 66 may include a browpad 88 for engaging the operator's brow to cushion, as well as dampen vibrations transmitted from the airframe 76 to the displays 22 to facilitate preventing distortion of the images viewed by the operator 82.

As shown in FIG. 6, the camera system 24 is mounted on an outer surface 90 of the airframe 76 and operatively connected to the displays 22 (FIG. 5) for receiving images of the refueling boom 70 and providing the received images to the displays. Specifically, the camera system 24 is mounted on the refueling pod 80 at a location where at least a portion of the refueling boom 70 is viewable by the camera system 24. As illustrated in FIGS. 5 and 6, the operator 82 (FIG. 5) can use the apparatus 66 to view stereoscopic images of the refueling boom 70 from within the aircraft 68 to control the boom when extending, engaging and retracting the boom, and refueling other aircraft 90, as well inspecting the boom and/or other portions of the aircraft during flight.

Although the invention is herein described and illustrated in association with an aircraft, the present invention is generally applicable to any vehicle. Accordingly, practice of the present invention is not limited to aircraft, nor is practice of the present invention limited to any specific aircraft described and/or illustrated herein. Although the invention is described and illustrated in association with viewing a refueling boom, the present invention is generally applicable to viewing other objects without departing from the scope of the present invention. Accordingly, practice of the present invention is not limited to viewing a refueling boom, nor any specific refueling boom described and/or illustrated herein. Furthermore, practice of the present invention is not limited to use with vehicles, but is generally applicable to viewing objects from positions not associated with vehicles.

Exemplary embodiments of apparatus, vehicles, and methods are described above in detail. The apparatus, vehicles, and methods are not limited to the specific embodiments described herein, but rather, components of each apparatus and/or vehicle may be utilized independently and separately from other components described herein, and steps of each method may be utilized independently and separately from other steps described herein. Each apparatus and/or vehicle component can also be used in combination with other apparatus and/or vehicle components. Additionally, each method step can also be used in combination with other method steps.

When introducing elements of the present invention or the preferred embodiment(s) thereof, the articles “a”, “an”, “the” and “said” are intended to mean that there are one or more of the elements. The term “plurality” is intended to mean there are two or more of the corresponding elements. The term “multiplicity” is intended to mean that there are three or more of the corresponding elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A stereoscopic display apparatus comprising:
a mount;
an arm connected to the mount for movement relative to the mount; and
a pair of independent visual displays mounted on the arm for movement relative to the mount so that the pair of displays is positionable for viewing by a user, a first display of said pair being adapted for viewing by a first eye of the user and a second display of said pair being adapted for viewing by a second eye of the user, each display of said pair being adapted to cooperate with the other display to provide images to the respective eye of the user that are perceived by the user as a three-dimensional image.

2. An apparatus in accordance with claim 1 wherein the arm has a first end and a second end opposite the first end, the first end of the arm is connected to the mount, and the pair of displays is mounted adjacent the second end of the arm.

3. An apparatus in accordance with claim 2 wherein the arm extends in a longitudinal direction and comprises an articulated portion, the second end of the arm is movable with respect to the mount in at least one of a vertical direction, a horizontal direction, and the longitudinal direction for positioning the pair of visual displays adjacent the user's eyes.

4. An apparatus in accordance with claim 1 further comprising a camera system operatively connected to the pair of visual displays for receiving images and providing said received images to the visual displays.

5. An apparatus in accordance with claim 1 further comprising a brow pad mounted adjacent the pair of visual displays for engaging the user's brow when the pair of visual displays are positioned adjacent the user's eyes.

6. A vehicle comprising:
a body;
an arm connected to the body for movement relative to the body; and
a pair of independent visual displays mounted on the arm for movement relative to the body so that the pair of displays is positionable for viewing by a user, a first display of said pair being adapted for viewing by a first eye of the user and a second display of said pair being adapted for viewing by a second eye of the user, each display of said pair being adapted to cooperate with the other display to provide images to the respective eye of the user that are perceived by the user as a three-dimensional image.

7. A vehicle in accordance with claim 6 wherein the arm has a first end and a second end opposite the first end, the first end of the arm is connected to the body, and the pair of displays is mounted adjacent the second end of the arm.

8. A vehicle in accordance with claim 7 wherein the arm extends in a longitudinal direction and comprises an articulated portion, the second end of the arm is movable with respect to the mount in at least one of a vertical direction, a horizontal direction, and the longitudinal direction for positioning the pair of visual displays adjacent the user's eyes.

9. A vehicle in accordance with claim 6 further comprising a camera system mounted on the body and operatively connected to the pair of visual displays for receiving images and providing said received images to the visual displays.

10. A vehicle in accordance with claim 6 further comprising a brow pad mounted adjacent the pair of visual displays for engaging the user's brow when the pair of visual displays are positioned adjacent the user's eyes.

11. A vehicle in accordance with claim 6 wherein the vehicle comprises an aircraft and the body comprises an airframe.

12. A vehicle comprising:
a body;
a pair of independent visual displays mounted on the body, a first display of said pair being adapted for viewing by a first eye of the user and a second display of said pair being adapted for viewing by a second eye of the user, each display of said pair being adapted to cooperate with the other display to provide images to the respective eye of the user that are perceived by the user as a three-dimensional image; and
a camera system mounted on the body and operatively connected to the pair of visual displays for receiving images and providing said received images to the visual displays.

13. A vehicle in accordance with claim 12 wherein the vehicle comprises an aircraft and the body comprises an airframe, said aircraft further comprising a refueling boom mounted on the airframe, said camera system being mounted on a location of the airframe where at least a portion of the refueling boom is viewable by the camera system.

14. A vehicle in accordance with claim 12 further comprising an arm mounted on the body, said pair of visual displays being mounted on the arm and said arm being movable with respect to the body for positioning the pair of visual displays adjacent the user's eyes.

15. A vehicle in accordance with claim 14 wherein the arm extends in a longitudinal direction and comprises an articulated portion, the second end of the arm is movable with respect to the mount in at least one of a vertical direction, a horizontal direction, and the longitudinal direction for positioning the pair of visual displays adjacent the user's eyes.

16. A vehicle in accordance with claim 11 further comprising a brow pad mounted adjacent the pair of visual displays for engaging the user's brow when the pair of visual displays are positioned adjacent the user's eyes.

17. A method for viewing an object adjacent a vehicle, said method comprising:
collecting an image of the object;
providing the image to a user on a pair of independent visual displays located on-board the vehicle and adapted for viewing by the user so that the images are perceived by the user as a three-dimensional image.

18. A method in accordance with claim 17 wherein the vehicle is an aircraft and the object is a refueling boom mounted on the aircraft.

19. A method in accordance with claim 17 further comprising dampening vibrations transmitted to the pair of visual displays by engaging the user's brow with a brow pad mounted adjacent the pair of visual displays.
